(19) United States
(12) Patent Application Publication
(10) Pub. No.: US 2017/0009693 A1
(43) Pub. Date: Jan. 12, 2017

(54) DIAGNOSING FAULT IN COMMON RAIL FUEL SYSTEM

(71) Applicant: Caterpillar Inc., Peoria, IL (US)

(72) Inventors: Nandagopal Methil, Dunlap, IL (US); Daniel R. Puckett, Peoria, IL (US)

(73) Assignee: Caterpillar Inc., Peoria, IL (US)

(21) Appl. No.: 15/260,818

(22) Filed: Sep. 9, 2016

Related U.S. Application Data
(62) Division of application No. 14/055,271, filed on Oct. 16, 2013.

(51) Int. Cl. F02D 41/22; F02D 41/30; F02D 41/14; F02M 55/02; F02M 63/02

(52) U.S. Cl. CPC F02D 41/221; F02M 55/025; F02M 63/025; F02D 41/1477; F02D 41/1401; F02D 41/3082; F02D 2041/142

(57) ABSTRACT

A method of diagnosing a fault in a common rail fuel system having a proportional-integral-derivative (PID) controller includes determining a first integral output corresponding to a first fuel flow condition and a first rail pressure setting. The method includes comparing the first integral output with a threshold integral output and determining a second integral output corresponding to a second fuel flow condition and the first rail pressure setting, when the first integral output is greater than the threshold integral output. The method includes determining a third integral output corresponding to the first fuel flow condition and a second rail pressure setting, when the first integral output is greater than the threshold integral output. The method includes identifying a failure in at least one of a flow control valve arrangement and a pressure relief valve of the common rail fuel system based on the first, second, and the third integral outputs.

### TECHNICAL FIELD

Present disclosure relates to a common rail fuel system and more particularly to a system and a method for diagnosing a fault in the common rail fuel system including a PID controller.

### BACKGROUND

Common rail fuel systems may utilize an electronically controlled high pressure pump to control fuel pressure in a common rail that is fluidly connected to a plurality of fuel injectors. Effective control of an engine utilizing a common rail fuel system may center on precise control over rail pressure, fuel injection timings and fuel injection quantities. A feedback control strategy, such as a proportional-integral-derivative (PID) controller, may be used to control output of a high pressure pump, to in turn control fuel pressure in the common rail.

Leakage in one or more components of a common rail fuel system may adversely affect performance of the common rail fuel system. When there is a leak and/or failure in a component of the common rail fuel system, the feedback control strategy compensates for the loss of fuel by providing more fuel than would otherwise be necessary into the common rail. Providing additional fuel into the common rail increases a value of the integral term in the PID controller. Consequently, an increased integral term may indicate a leak and/or failure in the common rail fuel system. Components that are prone to a leakage and/or failure may include, but are not limited to, injectors, the high pressure pump and pump components, the common rail, pressure relief valve, and flow control valve. Identifying the component that has failed may be a time consuming and labor intensive process.

U.S. Pat. No. 7,610,901 discloses a method for detecting the opening of a passive pressure control valve, which conducts fuel from a common rail system back to a fuel tank, in which the rail pressure (pCR) is automatically controlled by calculating a correcting variable for acting on the controlled system from a rail pressure control deviation via a pressure controller, and in which, starting from a steady-state rail pressure in normal operation, a load reduction is detected when the rail pressure exceeds a first limit. Opening of the pressure control valve is detected after the first limit is exceeded if a steady-state operating state is subsequently detected again, and if a characteristic of the closed-loop control system deviates significantly from a reference value.

### SUMMARY

In one aspect, the present disclosure provides a method of diagnosing a fault in a common rail fuel system having a proportional-integral-derivative (PID) controller. The method includes determining a first integral output of the PID controller corresponding to a first fuel flow condition and a first rail pressure setting. The method includes comparing the first integral output with a threshold integral output. The method includes determining a second integral output of the PID controller corresponding to a second fuel flow condition and the first rail pressure setting, when the first integral output is greater than the threshold integral output. The method includes determining a third integral output corresponding to the first fuel flow condition and a second rail pressure setting, the second rail pressure setting is lower than the first rail pressure setting, when the first integral output is greater than the threshold integral output. The method includes identifying a failure in at least one of a flow control valve arrangement and a pressure relief valve of the common rail fuel system based on the first, second, and the third integral outputs.

In one aspect, the present disclosure provides a common rail fuel system. The common rail fuel system includes a flow control valve arrangement provided upstream to a common rail. The common rail fuel system includes a pressure relief valve associated with the common rail. The common rail fuel system includes a proportional-integral-derivative (PID) controller in control communication with the flow control valve arrangement. The PID controller is configured to determine a first integral output of the PID controller corresponding to a first fuel flow condition and a first rail pressure setting. The PID controller is configured to compare the first integral output with a threshold integral output. The PID controller is configured to determine a second integral output of the PID controller corresponding to a second fuel flow condition and the first rail pressure setting, when the first integral output is greater than the threshold integral output. The PID controller is configured to determine a third integral output corresponding to the first fuel flow condition and a second rail pressure setting, the second rail pressure setting is lower than the first rail pressure setting, when the first integral output is greater than the threshold integral output. The PID controller is configured to identify a failure in at least one of the flow control valve arrangement and the pressure relief valve of the common rail fuel system based on the first, second, and the third integral outputs.

Other features and aspects of this disclosure will be apparent from the following description and the accompanying drawings.

### BRIEF DESCRIPTION OF THE DRAWINGS

FIG. 1 is a schematic view of an exemplary engine system;

FIG. 2 is a graph of an exemplary integral output during a failure in a flow control valve arrangement;

FIG. 3 is a graph of an exemplary integral output in during a failure in a pressure relief valve;

FIG. 4 is a flowchart for an exemplary method of diagnosing a fault in the flow control valve arrangement; and

FIG. 5 is a flowchart for an exemplary method of diagnosing a fault in the pressure relief valve.

### DETAILED DESCRIPTION

Reference will now be made in detail to specific embodiments or features, examples of which are illustrated in the accompanying drawings. Generally, corresponding or similar reference numbers will be used, when possible, to refer to the same or corresponding parts.

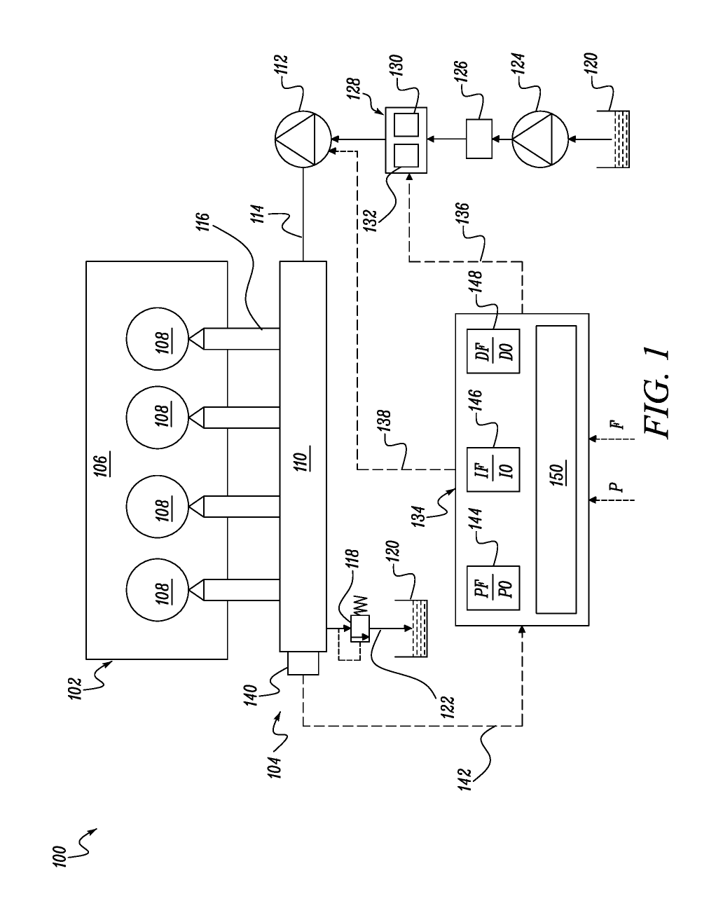

The present disclosure relates to a fault identification strategy for a common rail fuel system. FIG. 1 illustrates an exemplary schematic view of an engine system 100. The engine system 100 includes an engine 102 and a high pressure fluid system, such as a common rail fuel system 104. The engine 102 may include a direct injection compression ignition diesel engine, a spark ignited engine, or an engine with a different injection strategy. In the embodiment illustrated, the engine 102 includes a multi-cylinder direct injection compression ignition diesel engine including an engine housing 106 and one or more in-line cylinders 108.

The common rail fuel system 104 includes a pressurized rail, such as a common rail 110. An electronically controlled pump 112 is fluidly connected to the common rail 110 via an inlet line 114. The electronically controlled pump 112 includes a high pressure pump and may be any high pressure electric pump as commonly known in the art. A plurality of fuel injectors 116 corresponding to each of the cylinders 108 are fluidly connected to the common rail 110. A pressure relief valve 118 is associated with the common rail 110 and allows egress of fuel into a fuel tank 120 via an outlet line 122. In an exemplary embodiment, the pressure relief valve 118 includes a pilot pressure operated, one-way valve.

As illustrated in FIG. 1, the common rail fuel system 104 can include a low pressure pump 124 fluidly connected to the fuel tank 120. The low pressure pump 124 draws fuel from the fuel tank 120, and pushes the fuel through a filter 126 on its way to a flow control valve arrangement 128 provided upstream to the common rail 110. The flow control valve arrangement 128 is fluidly connected to the electronically controlled pump 112. In an embodiment the flow control valve arrangement 128 includes a pair of flow control valves (FCVs) 130, 132. The flow control valves 130, 132 may be any of a variety of two way or three way valves as commonly known in the art.

In the illustrated embodiment, the common rail fuel system 104 includes an electronic controller 134. The electronic controller 134 is in control communication with the flow control valve arrangement 128 and the electronically controlled pump 112 via a first, and a second communication line 136, 138 respectively. A rail pressure sensor 140 is configured to provide information indicative of a real time value of rail pressure in the common rail 110 to the electronic controller 134 via a third communication line 142.

In the illustrated embodiment, the electronic controller 134 includes a proportional integral derivative (PID) controller 134. The PID controller 134 includes a closed loop feedback controller using a PID controller algorithm. The PID controller 134 includes a proportional control 144, an integral control 146, and a derivative control 148. The PID controller algorithm may include a proportional gain factor (PF), an integral gain factor (IF), and a derivative gain factor (DF) associated with the proportional control 144, the integral control 146, and the derivative control 148, respectively. The PID controller 134 is configured to determine a proportional output (PO), an integral output (IO), and a derivative output (DO) as a function of the proportional gain factor (PF), the integral gain factor (IF), and the derivative gain factor (DF) respectively, based on rail pressure settings (P) of the common rail 110 and fluid flow conditions, such as fuel flow conditions (F) of the engine system 100. In one embodiment, the PID controller 134 is configured to determine the integral output (IO) as a function of target values and real time values for the rail pressure settings (P) and the fuel flow conditions (F). In an embodiment, the rail pressure settings (P) and the fuel flow conditions (F) may be determined by the PID controller 134 based on the operating conditions of the engine system 100. In alternative embodiments, the rail pressure settings (P) and the fuel flow conditions (F) may be provided by an operator.

The PID controller 134 can further include a memory unit 150 for example, but not limited to, a Random Access Memory (RAM), a Read Only Memory (ROM), flash memory, and/or a data structure. The memory unit 150 may be configured to store the proportional output (PO), the integral output (IO), and the derivative output (DO). In some embodiments, the memory unit 150 may include modulation curves, data tables, and/or module maps to dynamically update and store the proportional output (PO), the integral output (IO), and the derivative output (DO).

The memory unit 150 associated with the PID controller 134 may be configured to store a threshold integral output (Y). The threshold integral output (Y) may be a predetermined integral output (IO) which is indicative of an output of the integral control 146 corresponding to a steady state operation of the engine system 100.

The PID controller 134 may be configured to determine a first integral output (A) corresponding to a first fuel flow condition (F1) and a first rail pressure setting (P1). The PID controller 134 may be configured to compare the first integral output (A) with the threshold integral output (Y). If the first integral output (A) is greater than the threshold integral output (Y), the PID controller 134 may be configured to store the first integral output (A) in the memory unit 150. The PID controller 134 may also be configured to determine a second integral output (B) corresponding to a second fuel flow condition (F2) and the first rail pressure setting (P1) and a third integral output (C) corresponding to the first fuel flow condition (F1) and a second rail pressure setting (P2).

The first fuel flow condition (F1) and the second fuel flow condition (F2) may be inversely related. In an exemplary embodiment, the first fuel flow condition (F1) includes a high fuel flow condition and the second fuel flow condition (F2) includes a low fuel flow condition. The first rail pressure setting (P1) may be higher than the second rail pressure setting (P2). The first rail pressure setting (P1) may include a maximum design pressure for the common rail 110 and the second rail pressure setting (P2) may include a pressure lower than the maximum design pressure of the common rail 110.

The PID controller 134 may be configured to determine an absolute value for the first integral output (|A|), and an absolute difference (|A-B|) between the first integral output (A) and the second integral output (B). The PID controller may be configured to determine a difference (A-C) between the first integral output (A) and the third integral output (C). The differences (|A-B|) and (A-C) may be indicative of a dynamic range of operation of the integral control 146 for the respective rail pressure settings (P1, P2) and fuel flow conditions (F1, F2). In one embodiment, the differences (|A-B|) and (A-C) may be indicative of a first dynamic range (DR1) and a second dynamic range (DR2) of the integral control 146, respectively. The PID controller 134 may be configured to compare the first dynamic range (DR1) and/or the second dynamic range (DR2) with threshold integral output (Y).

In one embodiment, the PID controller 134 may be configured to detect a failure in the flow control valve arrangement 128, when the first dynamic range (DR1) is greater than the threshold integral output (Y). In another embodiment, the PID controller 134 may be configured to detect a failure in the pressure relief valve 118, when the second dynamic range (DR2) is greater than the threshold integral output (Y).

The PID controller 134 may be configured to generate an output indicative of the failure in the common rail fuel system 104. In one embodiment, the PID controller 134 may output audio and/or video signals indicative of the failure. In some embodiments, the video signals may include pictorial representations in forms of graphs indicative of the fault in the common rail fuel system 104. The output may be provided to the operator through an audio/visual device, for example, a display communicably coupled with the PID controller 134 disposed in an operator cabin.

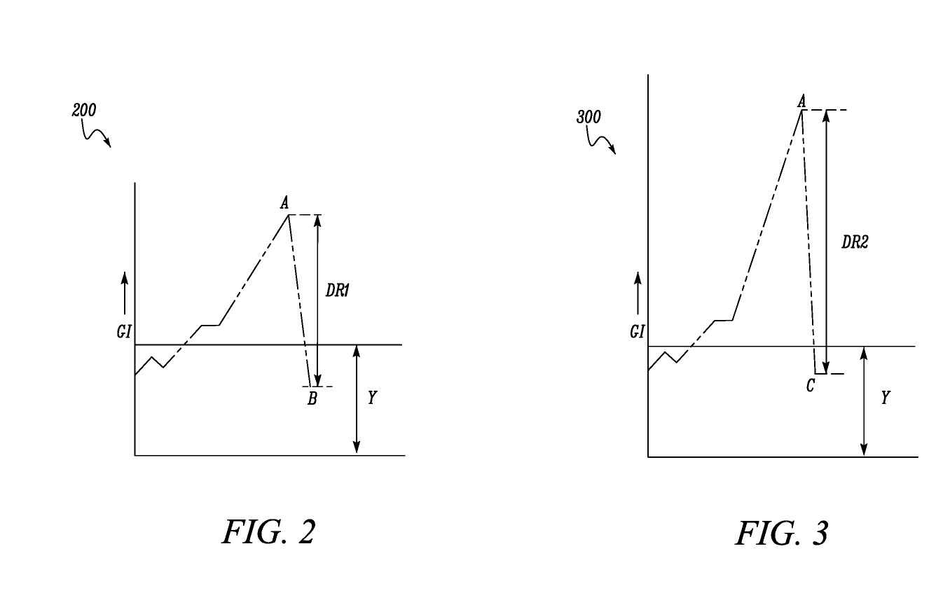

FIG. 2 illustrates a graph of an exemplary integral output (10) during a failure in the flow control valve arrangement 128. The solid line is indicative of the threshold integral output (Y). The dotted line is indicative of an exemplary integral output (10) during a failure in the flow control valve arrangement 128. The upward facing arrow is indicative of the first dynamic range (DR1) during the failure in the flow control valve arrangement 128.

In another exemplary embodiment, FIG. 3 is a graph illustrating an exemplary integral output (10) of the integral control 146 during a failure in the pressure relief valve 118. The solid line is indicative of the threshold integral output (Y). The dotted line is indicative of the integral output (10) during a failure in the pressure relief valve 118. The upward facing arrow is indicative of the second dynamic range (DR2) during the failure in the pressure relief valve 118.

### INDUSTRIAL APPLICABILITY

The PID controller 134 operates on a principle of minimizing an error between a target and real time values of the rail pressure settings (P) and the fuel flow condition (F). During a steady state operation of the engine system 100, the proportional output (PO) and the derivative output (DO) of the PID controller 134 are constant. Therefore, only a change in the value of the integral output (10) is observed for different rail pressure settings (P) and the fuel flow conditions (F). The integral output (IO) is indicative of an amount of fuel required, in addition to a feed forward amount of fuel, to achieve the target value of the rail pressure settings (P) and the fuel flow condition (F). Thus, an increase in the integral output (IO) above the threshold integral output (Y) may be indicative of the failure in the common rail fuel system 104. Further, the dynamic ranges, such as the first dynamic range (DR1) and the second dynamic range (DR2) are determined based on the integral outputs (A, B, C) at different rail pressure settings (P1, P2) and fuel flow conditions (F1, F2) to effectively detect the failure in the flow control valve arrangement 128 and/or the pressure relief valve 118.

As described above, if there is a failure in the pressure relief valve 118, the pressure relief valve 118 may open prematurely at a rail pressure lower than the target value of the rail pressure settings (P). The rail pressure sensor 140 communicates a loss of rail pressure, due to the premature opening, to the PID controller 134 and increases the integral output (IO). Similarly in case of a failure of one of the flow control valves 130 in the flow control valve arrangement 128, the electronically controlled pump 112 will receive a lower amount of fuel. To compensate for the loss of fuel the PID controller 134 is configured to increase an amount of fuel supplied by another flow control valve 132 by increasing the integral output (IO). Conventionally, on observing a high integral output, the operator is required to manually check the common rail fuel system 104 to detect a failed component. With the system and method of the present disclosure, the use of the integral outputs (A, B, C) and the dynamic ranges (DR1, DR2) of the integral control 146 allows the operator to automatically detect and distinguish the failure in the pressure relief valve 118 and the fuel control valve arrangement 128.

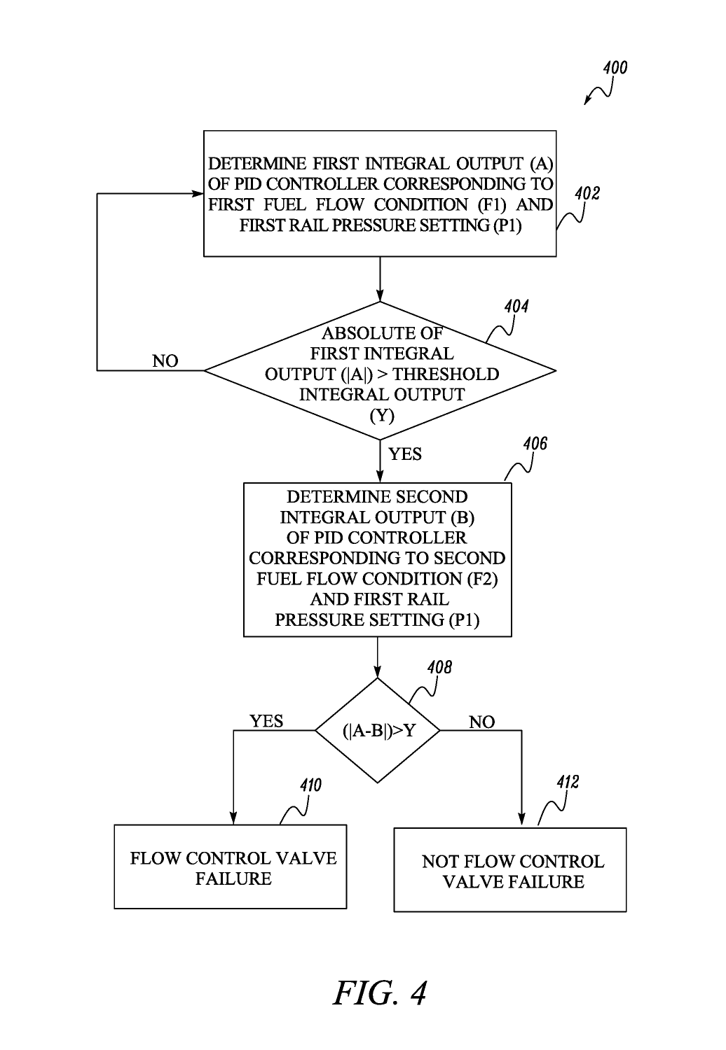

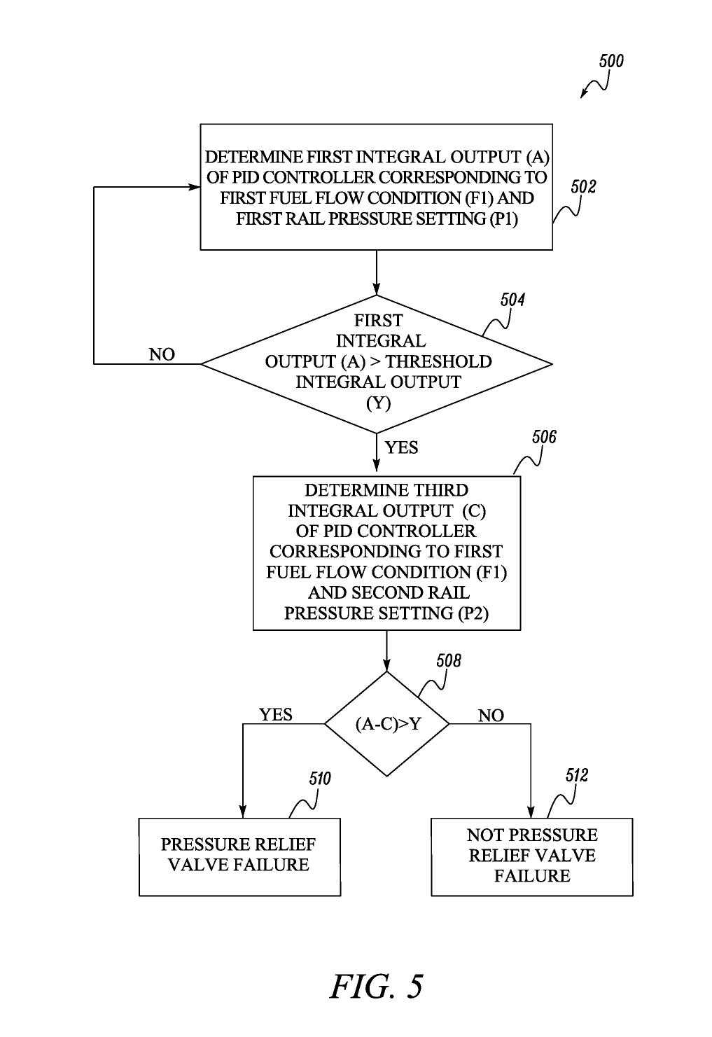

FIG. 4 illustrated a flowchart for an exemplary method 400 of diagnosing a fault in the flow control valve arrangement 128 of the common rail fuel system 104. At step 402 of the method 400, during the steady state operations of the engine system 100, the PID controller 134 determines the first integral output (A) of the integral control 146 corresponding to the first fuel flow condition (F1) and the first rail pressure setting (P1). At step 404, the PID controller 134 compares the absolute value of the first integral output (|A|) with the threshold integral output (Y). The method 400 includes repeating steps 402 and 404 until the absolute value of the first integral output (|A|) is greater than the threshold integral output (Y).

At step 406, the PID controller 134 determines the second integral output (B) corresponding to the second fuel flow condition (F2) and the first rail pressure setting (P1), if the first integral output (A) is greater than the threshold integral output (Y) (Step 404: YES). Moreover, if the first integral output (A) is remains equal to or less than the threshold integral output (Y), the method 400 goes back to step 402. In an embodiment, the first fuel flow condition (F1) and the second fuel flow condition (F2) are inversely related.

At step 408, the PID controller 134 determines the difference (|A-B|) between the first integral output (A) and the second integral output (B) and compares the difference (|A-B|) with the threshold integral output (Y). The method 400 indicates a failure in at least one of the flow control valve 130 or 132 of the flow control valve arrangement 128 in the common rail fuel system 104, at step 410, when the difference (|A-B|) between the first integral output (A) and the second integral output (B) is greater than the threshold integral output (Y) (Step 408: YES). Further, in case the difference (|A-B|) between the first integral output (A) and the second integral output (B) equal to or less than greater than the threshold integral output (Y) (Step 408: NO), the method 400 indicates no failure in the flow control valves 130 or 132.

FIG. 5 is a flowchart illustrating an exemplary method 500 of diagnosing a fault in the pressure relief valve 118 of the common rail fuel system 104. At step 502 of the method 500, during the steady state operations of the engine system 100, the PID controller 134 determines the first integral output (A) of the integral control 146 corresponding to the first fuel flow condition (F1) and the first rail pressure setting (P1). At step 504, the PID controller 134 compares the first integral output (A) with the threshold integral output (Y). At step 506, the PID controller 134 determines the third integral output (C) corresponding to the first fuel flow condition (F1) and the second rail pressure setting (P2), if the first integral output (A) is greater than the threshold integral output (Y) (Step 504: YES). Moreover, if the first integral output (A) is equal to or less than the threshold integral output (Y), the method 500 goes back to step 502. In an embodiment, the first rail pressure setting (P1) may corresponds to the maximum design pressure for the common rail and the second rail pressure setting (P2) is lower than the first rail pressure setting (P1). In an exemplary embodiment, the second rail pressure setting (P2) is lower than the real time value of the rail pressure (P) at the first fuel condition (F1).

At step 508, the PID controller 134 determines the difference (A-C) between the first integral output (A) and the third integral output (C) and compares with the threshold integral output (Y). The method 500 indicates a failure in the pressure relief valve 118 in the common rail fuel system 104, at step 510, when the difference (A-C) between the first integral output (A) and the third integral output (C) is greater than the threshold integral output (Y) (Step 508: YES). Further, in case the difference (A-C) between the first integral output (A) and the third integral output (C) equal to or less than greater than the threshold integral output (Y) (Step 408: NO), the method 400 indicates no failure in the pressure relief valve 118.

Moreover, those skilled in the art will appreciate that the logics expressed by the methods 400, 500 could be encoded for execution by the PID controller in a wide variety of ways without departing from the present disclosure.

From the foregoing it will be appreciated that, although specific embodiments have been described herein for purposes of illustration, various modifications or variations may be made without deviating from the spirit or scope of inventive features claimed herein. Other embodiments will be apparent to those skilled in the art from consideration of the specification and figures and practice of the arrangements disclosed herein. It is intended that the specification and disclosed examples be considered as exemplary only, with a true inventive scope and spirit being indicated by the following claims and their equivalents

What is claimed is:

1. A common rail fuel system comprising:
a flow control valve arrangement provided upstream to a common rail;
a pressure relief valve associated with the common rail; and
a proportional-integral-derivative (PID) controller in control communication with the flow control valve arrangement, the PID controller is configured to:
determine a first integral output of the PID controller corresponding to a first fuel flow condition and a first rail pressure setting;
compare the first integral output with a threshold integral output;
determine a second integral output of the PID controller corresponding to a second fuel flow condition and the first rail pressure setting, when the first integral output is greater than the threshold integral output;
determine a third integral output corresponding to the first fuel flow condition and a second rail pressure setting, the second rail pressure setting is lower than the first rail pressure setting, when the first integral output is greater than the threshold integral output; and
detect a failure in at least one of the flow control valve arrangement and the pressure relief valve in the common rail fuel system based on the first, second, and the third integral output.

2. The common rail fuel system of claim 1, wherein the PID controller further configured to determine a difference between the first integral output and the second integral output.

3. The common rail fuel system of claim 2, wherein the PID controller further configured to detect the failure in the flow control valve arrangement, when the difference between the first integral output and the second integral output is greater than the threshold integral output.

4. The common rail fuel system of claim 1, wherein the PID controller further configured to determine a difference between the first integral output and the third integral output.

5. The common rail fuel system of claim 4, wherein the PID controller further configured to detect the failure in the pressure relief valve, when the difference between the first integral output and the third integral output is greater than the threshold integral output.

6. The common rail fuel system of claim 1, wherein the PID controller further configured to monitor a rail pressure in the common rail using a pressure sensor.

7. The common rail fuel system of claim 1 further comprises an electronically controlled pump, wherein the PID controller is in control communication with the electronically controlled pump.

8. A high pressure fluid system comprising:
a flow control valve arrangement provided upstream to a pressurized rail;
a pressure relief valve associated with the pressurized rail; and
a proportional-integral-derivative (PID) controller in control communication with the flow control valve arrangement, the PID controller is configured to:
determine a first integral output of the PID controller corresponding to a first fluid flow condition and a first rail pressure setting;
compare the first integral output with a threshold integral output;
determine a second integral output of the PID controller corresponding to a second fluid flow condition and the first rail pressure setting, when the first integral output is greater than the threshold integral output;
determine a third integral output corresponding to the first fluid flow condition and a second rail pressure setting, the second rail pressure setting is lower than the first rail pressure setting, when the first integral output is greater than the threshold integral output; and
detect a failure in at least one of the flow control valve arrangement and the pressure relief valve in the high pressure fluid system based on the first, second, and the third integral output.

9. The high pressure fluid system of claim 8, wherein the PID controller further configured to determine a difference between the first integral output and the second integral output.

10. The high pressure fluid system of claim 9, wherein the PID controller further configured to detect the failure in the flow control valve arrangement, when the difference between the first integral output and the second integral output is greater than the threshold integral output.

11. The high pressure fluid system of claim 8, wherein the PID controller further configured to determine a difference between the first integral output and the third integral output.

12. The high pressure fluid system of claim 11, wherein the PID controller further configured to detect the failure in the pressure relief valve, when the difference between the first integral output and the third integral output is greater than the threshold integral output.

13. The high pressure fluid system of claim 8 is a common rail fuel system associated with an engine system.
